(19) United States
(12) Patent Application Publication
(10) Pub. No.: US 2006/0114892 A1
(43) Pub. Date: Jun. 1, 2006

(54) Method and apparatus to transmit state information through a communication link

(76) Inventors: Woojong Han, Phoenix, AZ (US); Gary Solomon, Acton, MA (US)

Correspondence Address: INTEL CORPORATION, P.O. BOX 5326, SANTA CLARA, CA, 95056-5326, US

(21) Appl. No.: 10/998,703

(22) Filed: Nov. 29, 2004

(51) Int. Cl. H04L 12/56

(52) U.S. Cl. 370/389

(57) ABSTRACT

A method and apparatus to transmit state information through a communication link. In an example embodiment, an endpoint on a communication link receives a state packet in a first format from a first device. The state packet is translated into a second format to generate a translated packet. The translated packet suitable for communicating the state information through the communication link to another endpoint on the communication link.

### TECHNICAL FIELD

Embodiments of invention generally relate to the field of electronic systems, and more particularly, to a method and apparatus to transmit state information through a communication link.

### BACKGROUND

Communication networks may be constructed of packet switched channels. Endpoints on these packet switched channels may receive data from a device. These endpoints may reside between multiple (two or more) networks. Thus, the data received from the device may have a destination that routes the data through the endpoint's network to another network. Upon receipt of the data, the receiving endpoint may forward the data to another endpoint. The other endpoint may then forward the data to yet another device, the other device possibly residing on another network.

As mentioned above, the devices and endpoints referred to above may well reside on multiple networks. Each network may have its own disparate packet format for forwarding data. Thus, data in a packet format received at an endpoint from a device on a first network may be incompatible with the packet format of another network.

In general, to forward data received from a first network in an incompatible packet format, a receiving endpoint may keep the data in the incompatible packet format. The endpoint may then wrap additional headers containing route and handling information around the data in the incompatible packet format. The receiving endpoint uses these additional headers to route the wrapped packet to another endpoint. Once the wrapped packet reaches the other endpoint, the additional headers are removed, as the packet is “unwrapped.” The data in the originally received packet format is then forwarded towards its destination. This process is commonly known as “encapsulation.”

Some packet formats may be designed to only transmit data between devices and/or endpoints coupled in communication on a communication link (hereinafter referred to as “communication link partners”). Packets in these formats are to be terminated at the communication link partner and not forwarded or encapsulated. This is problematic, for example, when data contained in these packet formats needs to be relayed between two devices but the devices are not communication link partners. This problem may become more complex when the destination for the data may require the routing of data through different networks, each network having their own disparate and incompatible packet format.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a block diagram of an example device to communicate state information to another device, according to one embodiment;

FIG. 2 is a block diagram of an example translation manager, according to one embodiment;

FIG. 3 is a graphical illustration of example state information transmitted between PCI-Express devices through an Advanced Switching (AS) fabric in an electronic system, according to one embodiment;

FIG. 4a is a graphical illustration of a state packet format, according to one embodiment;

FIG. 4b is an example table illustration of state information encoding parameters for a power management state packet, according to one embodiment;

FIG. 5a is a graphical illustration of an example translated packet format, according to one embodiment;

FIG. 5b is an example table illustration of encoding parameters for a translated power management packet, according to one embodiment; and

FIG. 6 is a flow chart of an example method to transmit state information through a communication link, according to one embodiment.

### DETAILED DESCRIPTION

Embodiments of the invention are generally directed to a method and apparatus to transmit state information through a communication link. In accordance with one example embodiment, a translation manager is introduced herein. As described more fully below, the innovative translation manager is responsive to an endpoint on a communication link and translates a packet from a first packet format to a second packet format.

According to one embodiment, a packet is received by an endpoint from a first device. The packet (hereinafter referred to as a “state packet”) includes, in whole or in part, state information associated with the first device. The state packet is in a first packet format. A translation manager responsive to the endpoint translates the state packet to a second packet format. The state packet translation may result in the generation of a translated packet in the second packet format that is suitable for communicating the device's state information through a communication link to another endpoint.

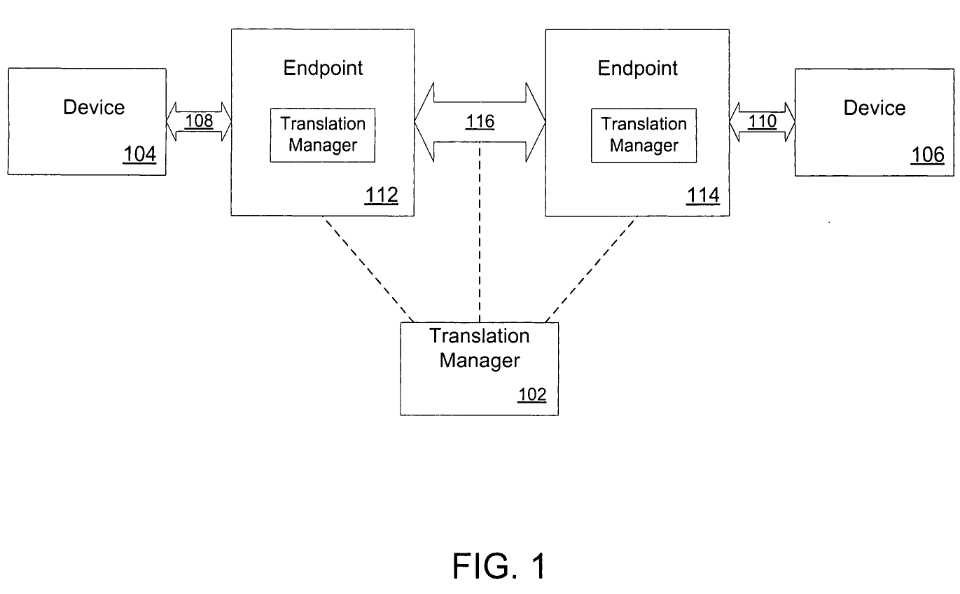

FIG. 1 is a block diagram of an example device to communicate state information to another device, according to one embodiment. In FIG. 1, translation manager 102, devices 104 and 106, communication links 108 and 110, endpoints 112 and 114 and switch fabric 116 are each coupled as depicted, although the invention is not limited in this regard.

In accordance with one embodiment, a state packet may be transmitted from a first device (e.g., device 104) to a second device (e.g., device 106) through a series of communication links. The communication links, or at least a subset thereof, may utilize different packet formats, each packet format associated with a communication protocol. The state packet may contain information associated with one or more of device power management states, hot swap resets, temperatures, malfunctions, etc., although the invention is not limited in this regard.

According to one example embodiment, device 104 may transmit a state packet across communication link 108. The state packet may be in a first packet format associated with a particular communication protocol. However, the first packet format may not be in a format suitable for transmission across other types of communication link(s) such as, e.g., switch fabric 116. Accordingly, an instance of translation manager 102 may be invoked to translate the state packet into a second packet format. The translation manager 102 may generate a translated packet to facilitate transmission of the device's state information through switch fabric 116 to endpoint 114.

Once the translated packet is received by endpoint 114, translation manager 102 may then decode the translated packet into a format more suited for transmission of information through communication link 110. Once decoded, translation manager 102 may generate another state packet in the more suitable format. The other state packet is then forwarded through communication link 110 to communicate device 104's state information to device 106.

In an example implementation, translation manager 102 may translate and decode a packet within endpoint 112 and endpoint 114, respectively. This may occur with little to no external software intervention. In another example implementation, translating and decoding may occur externally to endpoint 112 and endpoint 114. For example, by software and/or hardware functioning as a fabric manager (not shown in FIG. 1), e.g., on switch fabric 116, although the scope of the invention is not so limited.

In an example embodiment, endpoint 112 and/or endpoint 114 may be an element(s) of an electronic system. As part of the electronic system, endpoints 112 and 114 may act as intermediary nodes for forwarding and/or processing data transmitted and/or received from a device located within and/or remote to the electronic system. Endpoints 112 and/or 114 may be responsive to a power source of the electronic system and may represent any of a number of hardware element(s) to receive, process and transmit data within or remote to the electronic system. Thus, in one embodiment, endpoints 112 and 114 may provide processing resources to the electronic system and may comprise one or more of, an embedded logic, microprocessor, an intermediary switch for a switch fabric or the like.

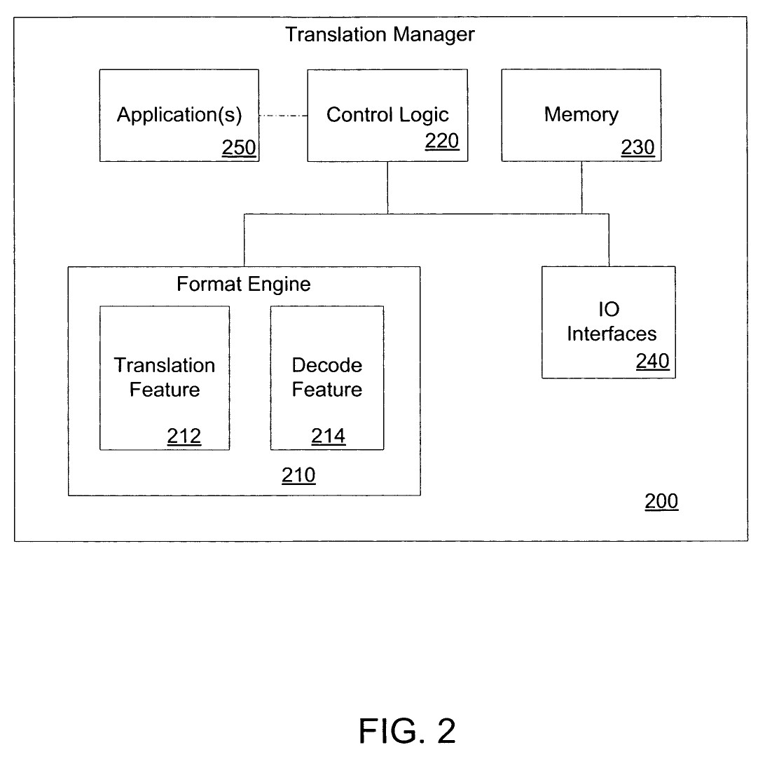

FIG. 2 is a block diagram of an example translation manager, according to one embodiment. According to one example embodiment, translation manager 200 may include one or more of a format engine 210, control logic 220, memory 230, input/output (IO) interfaces 240, and optionally one or more application(s) 250, each coupled as depicted. It should be appreciated, based on the discussion to follow, that although depicted including a number of disparate functional elements, two or more of such elements may well be combined into a multifunctional element, or one element may be broken into two or more elements. In this regard, translation manager architectures of greater or lesser complexity are anticipated within the scope of the claimed invention.

In FIG. 2, format engine 210 may include one or more of a translation feature 212 and decode feature 214. As developed more fully below, translation feature 212 translates a state packet received at an endpoint (e.g. endpoint 112) from a device, (e.g. device 104). The state packet translation may generate a translated packet to facilitate transmission of state information through a communication link (e.g. switch fabric 116) to another endpoint (e.g. endpoint 114). Decode feature 214 may then decode the received translated packet. Once the translated packet is decoded, decode feature 214 may generate another state packet in a format suitable for forwarding the other state packet through another communication link (e.g. communication link 110) to another device (e.g. device 106)

As used herein, control logic 220 may control the overall operation of translation manager 200. Control logic 220 is intended to represent any of a wide variety of logic device(s) and/or executable content to implement the operation of translation manager 200, described herein. Control logic 220 may well include, but is not limited to, a microprocessor, network processor, microcontroller, field programmable gate array (FPGA), application specific integrated circuit (ASIC), or executable content to implement such control features, and/or any combination thereof. In alternate embodiments, the features and functionality of control logic 220 may well be implemented within format engine 210.

In an example embodiment, control logic 220 may invoke an instance of format engine 210 to translate state packets. The state packet translation may generate a translated packet suitable for communicating the state information through a communication link. Control logic 220 may also invoke an instance of format engine 210 to decode the translated packet. The decoding may include the generation of another state packet.

As used herein, memory 230 is intended to represent a wide variety of memory media including, but not limited to volatile memory, non-volatile memory, flash and programmatic variables or states. According to an example embodiment, format engine 210 uses memory 230 to temporarily store one or more translation tables. The translation tables may contain information to translate and/or decode packets into different formats.

Memory 230 may also store executable content. The executable content may be used by control logic 220 to implement an instance of format engine 210.

In an example embodiment, a form of machine-accessible medium may provide machine-readable instructions to memory 230. As used herein, a machine-accessible medium is intended to represent any mechanism that provides (i.e., stores and/or transmits) information in a form readable by a machine or device (e.g., endpoint 114). For example, a machine-accessible medium may well include read only memory (ROM); random access memory (RAM); magnetic disk storage media; optical storage media; flash memory devices; electrical, optical, acoustical or other form of propagated signals (e.g., carrier waves, infrared signals, digital signals); and the like.

As used herein, IO interfaces 240 provides a communications interface between translation manager 200 and an electronic system. For example, translation manager 200 may be implemented as an element of a communication network, wherein IO interfaces 240 provides a communication interface between translation manager 200 and the communication network via a communication channel. In this regard, control logic 220 can receive a series of instructions from application software external to translation manager 200 via IO interfaces 240. The series of instructions may invoke control logic 220 to implement one or more features of format engine 210.

In an example embodiment, translation manager 200 may include one or more application(s) 250 to provide internal instructions to control logic 220. As used herein, such application(s) 250 may well be invoked to generate a user interface, e.g., a graphical user interface (GUI), to enable administration features, and the like. In alternate embodiments, one or more features of format engine 210 may well be implemented as an application(s) 250, invoked by control logic 220 to invoke such features.

In one embodiment, endpoint 112 and/or endpoint 114 may include an instance of a translation manager (as shown in FIG. 1). In this regard, a format engine 210 may invoke an instance of a translation feature 212 to translate a state packet from one packet format to another packet format. The state packet received by endpoint 112 from device 104 across communication link 108.

In this example embodiment, translation feature 212 reads at least a portion of the received state packet. Translation feature 212 may then access a translation table (not particularly denoted) in memory 230. The translation table may contain encoding parameters, as explained in more detail below, for translating the state packet. Translation feature 212, based on the translation table, generates a translated packet in another format. Endpoint 112 may then transmit the translated packet through switch fabric 116 to endpoint 114.

Once endpoint 114 receives the translated packet, endpoint 114 may invoke an instance of format engine 210. Format engine 210 may then invoke an instance of decode feature 214. Decode feature 214 may read at least a portion of the translated packet. Decode feature 214 may then access a translation table (not particularly denoted) in memory 230. The translation table may contain decoding parameters for the translated packet, as explained in more detail below. Decode feature 212, based on the translation table, decodes the translated packet. In an example implementation, decode feature 212 decodes the translated packet to generate another state packet in the original state packet format.

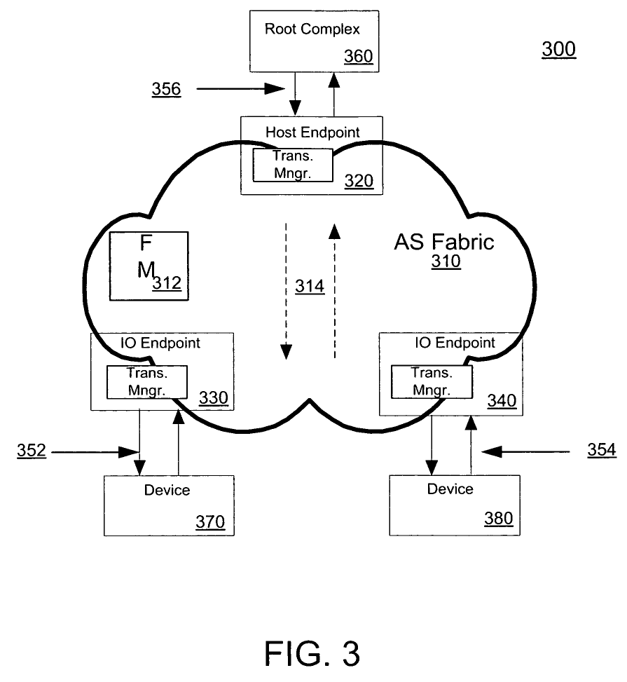

FIG. 3 is a graphical illustration of example state information transmitted between PCI-Express devices through an Advanced Switching (AS) fabric in an electronic system, according to one embodiment. Electronic system 300 may be, for example, a server, a network switch or a router for a modular platform in a telecommunications network, although the invention is not limited in this regard.

Electronic system 300 includes one or more of an AS fabric 310, host endpoint 320, IO endpoint 330, IO endpoint 340, devices 360 and 370, root complex 380, and PCI-Express communication links 352, 354 and 356, each coupled as depicted.

In one embodiment, devices 330 and 340 and root complex 360 are PCI-Express devices that are each connected on PCI-Express communication links to endpoints on AS fabric 310. Each of the above devices uses a packet format associated and/or compliant with the communication protocols described in the PCI-Express Base Specification, Rev. 1.0a, published Apr. 15, 2003 (hereinafter referred to as “the PCI-Express Specification”) to transmit state information through communication links 352, 354 and 356. Additionally, endpoints 360, 370 and 380, connected via AS communication links 314, use a packet format associated and/or compliant with the communication protocols described in the Advanced Switching Core Architecture Specification, Rev. 1.0, published December 2003 (hereinafter referred to as “the AS Core Specification), and also described in the PCI-Express to Advanced Switching Bridge Architecture Specification, Rev. 1.0, published February 2004 (hereinafter referred to as “the PI-8 Specification”).

In addition to PCI-Express, the AS Core Specification works with various other communication protocols (e.g., Ethernet, ATM, SONET, etc.). As with PCI-Express, these communication protocols are associated with a particular packet format. The AS Core Specification assigns an interface (hereinafter called a “protocol interface” or “PI”) to each of these various communication protocols. One task for each assigned PI may be preparing packets for data received in a particular packet format for transport across an AS fabric. In this regard, the AS Core Specification contains a reference to various other AS specifications which describe how a PI prepares packets for transport across an AS fabric.

One such AS specification is for the transportation of packets received in a format associated with PCI-Express communication protocols. This AS specification is the PI-8 Specification. In accordance with the PI-8 Specification, endpoints connected to a root device or to a PCI-Express device closest to the root device, are deemed as a “host switch.” All other endpoints are deemed as “IO switches.” Thus, in the example embodiment of FIG. 3, host endpoint 320 is a host switch connected to root complex 360 and IO endpoints 330 and 340 are IO switches.

In one embodiment, a type of state information transmitted from a PCI-Express device through AS fabric 310 to another PCI-Express device may be power management information. A mechanism for which power management information is transmitted from a PCI-Express device to another PCI-Express device is called the PCI Bus Power Management Interface (PCI-PM).

The PCI-PM mechanism communicates power management state information through the use of a packet called a data link layer packet (DLLP). As will be explained in more detail below, each power management DLLP is in a packet format described in the PCI-Express Specification. DLLP use is not limited to power management information, a DLLP may also indicate other device state information, such as for example, hot swaps, temperatures, malfunctions, etc. According to one embodiment, the term “state packet”, as used above, may be used interchangeably herein with the term “DLLP,” although the invention is not limited in this regard.

In an example embodiment, a power management state packet is transmitted from one PCI-Express device (e.g., device 370) with a destination to another PCI-Express device (e.g., device 380). The devices are not communication link partners and the state packet is to be transported through an endpoint (e.g., IO endpoints 330, 340 or host endpoint 320) coupled to an AS fabric (e.g., AS fabric 310) before reaching the other PCI-Express device. Thus, the state packet is first transmitted from the device to an endpoint on the AS fabric.

According to the PCI-Express Specification, state packets are designed to be terminated by the communication link partner. In this example embodiment, the communication link partner is an endpoint on the AS fabric. However, if the state packet is terminated by the endpoint, then power management information will not reach the intended PCI-express device. Accordingly, as explained in more detail below, the power management state packets may be translated to avoid termination of the state packet at the endpoint.

AS fabric 310 includes a fabric manager (FM) 312. In one embodiment, FM 312 manages the AS fabric 310. FM 312 may, as part of that management, perform both translation and decoding of packets transmitted through AS fabric 310. In this regard, translation manager 102 may be implemented within FM 312.

In the example embodiment of FIG. 3, each endpoint is depicted as having a translation manager (e.g. translation manager 102). Each translation manager may perform both translation and decoding of state packets at each endpoint without the intervention of FM 312 or other software that is external to each endpoint.

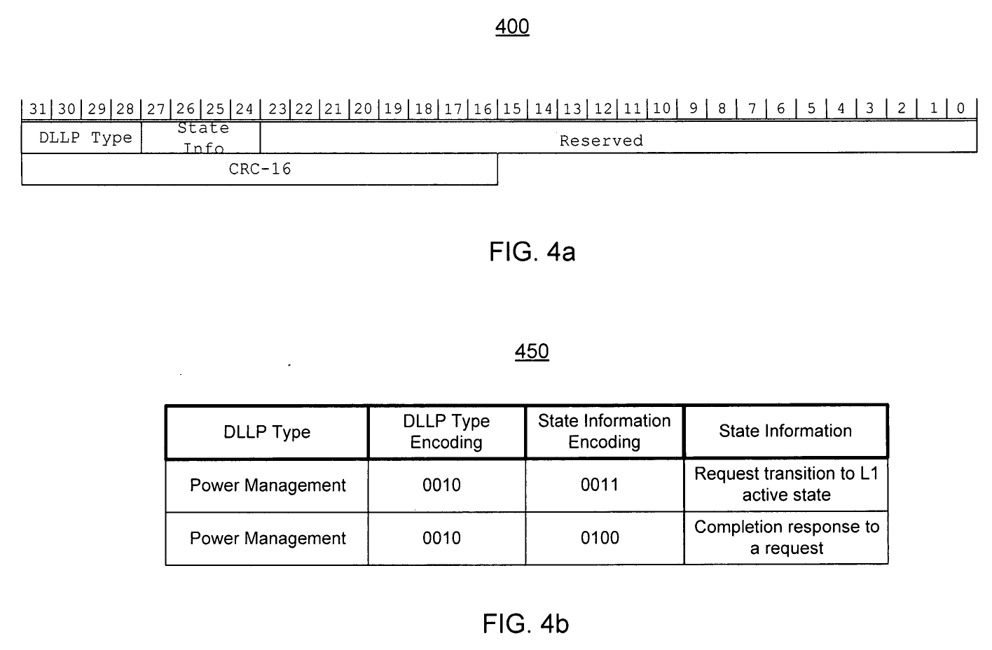

FIG. 4a is a graphical illustration of state packet format 400, according to one embodiment. State packet 400 includes 32-bits of data with a 16-bit cyclic redundancy check. State packet 400 includes fields to indicate state type and other state information. The state type field in bits 28-31 indicates the type of state information, such as power management, hot swapping, temperature, etc., although the invention is not limited in this regard. The state information field in bits 24-27 indicates what state information is being transmitted, such as power down, start-up, high temperatures, etc., although the invention is not limited in this regard.

In an example embodiment, a state packet/DLLP designed to be terminated at the link partner on a PCI-Express communication link is transmitted from device 370 to root complex 360. As shown in FIG. 3, device 370 and root complex 360 are not communication link partners. Thus, to convey the power management state information to root complex 360, the state packet in the packet format of state packet 400 needs to be translated at IO endpoint 330 (e.g. by translation manager 102). The state packet translation may result in the generation of a translated packet suitable for communicating the power management state information through AS fabric 310 to host endpoint 320. IO endpoint 330 then sends the translated packet across AS fabric 310 to host endpoint 320. At host endpoint 320, the translated packet is decoded (e.g. by translation manager 102). Once decoded, another state packet may be generated in the packet format of state packet 400. The other state packet is then transmitted by host endpoint 320 to root complex 360 through PCI-Express communication link 356.

FIG. 4b is an example table illustration of state information encoding parameters for a power management state packet, according to one embodiment. In FIG. 4b, table 450 is depicted as including example PCI-Express state information encoding parameters. The encoding parameters correspond to power management state information in bits 28-31 and 24-27 of state packet 400, although the invention is not limited in this regard.

In an example embodiment, transition to an LI power state is a request made by a device (e.g., device 370) to enter into a lower power state. This may include, for example, transitioning the communication link (e.g. communication link 352) to a lower power state. Once the destination device (e.g., root complex 360) receives the request for a transition to LI, a completion response is sent by the destination device back to the device requesting the transition to LI.

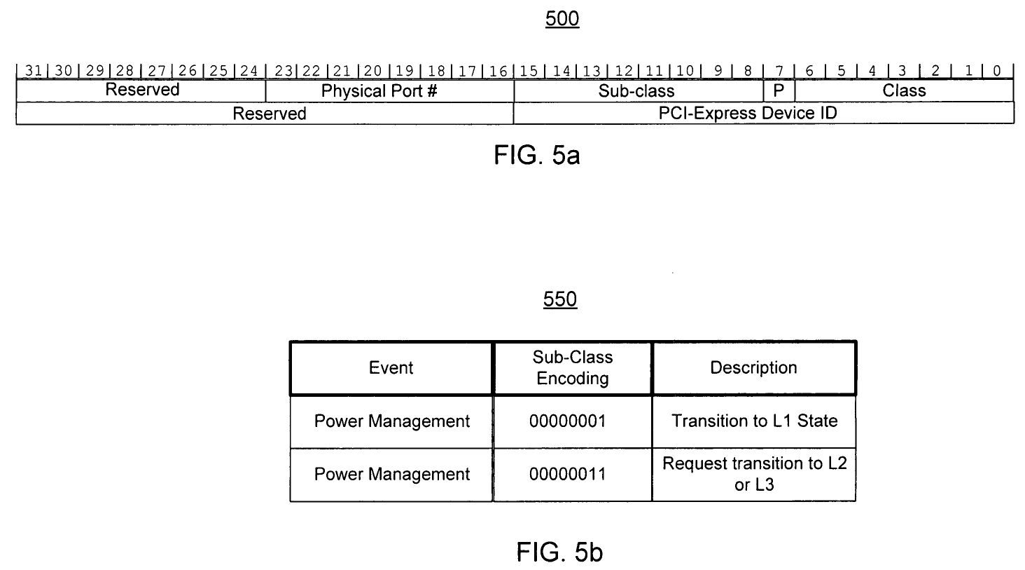

FIG. 5a is a graphical illustration of example translated packet format 500, according to one embodiment. According to the illustrated example embodiment, translated packet 500 may contain two 32-bit words or two double-words (hereinafter referred to as a “dword”). At least a portion of the first dword includes the translated state information of a device communicating that information across a switch fabric to another device. At least a portion of the second dword includes information related to the PCI-Express device that is the source of the state information being communicated. Although the scope of the invention is not limited to this particular dword format.

In an example embodiment, translated packet 500 is formatted according to the AS event packet format defined in the AS Core Specification. The first dword of translated packet 500 contains bits 0-6, shown in FIG. 5a as the “class” field. The class field in bits 0-6 is used (e.g. by an endpoint on AS fabric 310) to identify whether the translated packet is to be translated by the PI-8 interface (also known as the PCI-Express to Advanced Switching bridge), although the invention is not limited in this regard.

According to one example embodiment, the AS Core Specification assigns a binary encoding of “000100” for PI-8 communications. Accordingly, bits 0-6 for translated packet 500 may be encoded as 000100 when communicating PCI-Express information, although the scope of the invention is not limited to this particular encoding. Additionally, the “p” field in bit 7 indicates that translated packet 500 is a PI-8 specific event. In particular, a PI-8 specific event communicating device state information through the AS fabric.

The “sub-class” field in bits 8-15, contains PI-8 specific event encodings for translating a state packet received for a device. Example encoding parameters for the “sub-class” field are described in more detail below.

The “physical port #” field in bits 16-23, identifies the location of the endpoint receiving the state information from a PCI-Express device. The location being the endpoint's particular location on a switch fabric. In an example implementation, each endpoint is assigned a unique port address number to facilitate the routing of translated packets through an AS fabric, although the invention is not limited in this regard.

The “PCI-Express Device ID” field in bits 0-15 indicates the identification (ID) of the PCI-Express device that transmitted the state packet, although the invention is not limited in this regard.

The remaining fields of the first and second dwords in translated data packet 500 are AS fabric specific and are reserved.

FIG. 5b is an example table illustration of encoding parameters for a translated power management packet, according to one embodiment. In FIG. 5b, table 550 is depicted as including example PI-8 specific event encoding parameters for translating and decoding PCI-Express state information.

Table 550 illustrates the power management encoding parameters in bits 8-15 of translated power management packet 500, although the invention is not limited to the encoding parameters shown in table 550.

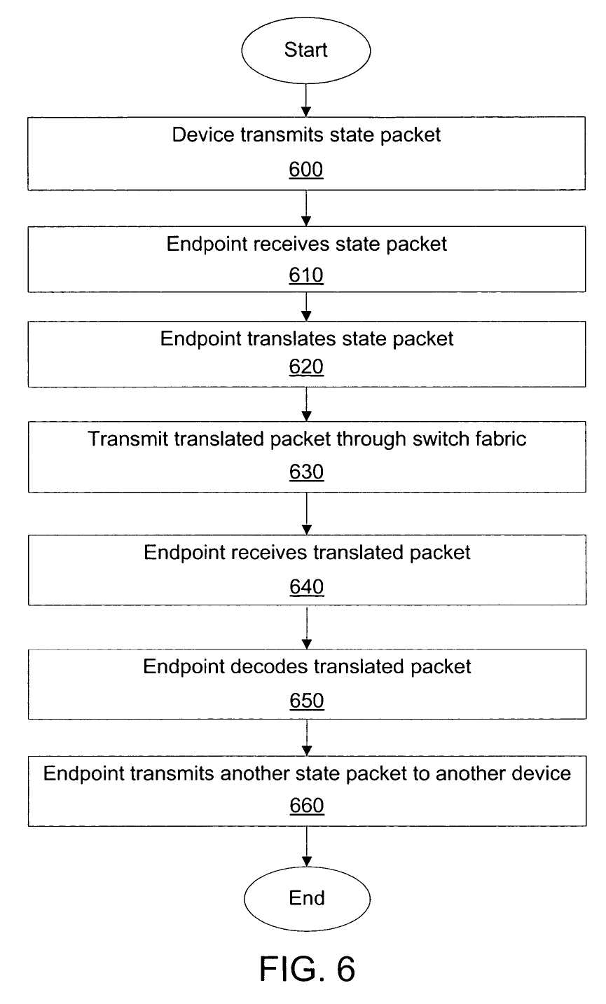

FIG. 6 is a flow chart of an example method to transmit state information through a communication link, according to one embodiment. For purposes of illustration, and not limitation, the example method of FIG. 6 will be developed in accordance with an example PCI-Express to Advanced Switching bridging implementation as described above (e.g., FIG. 3). Accordingly, the method of FIG. 6 begins in block 600 where, in one embodiment, device 370 of electronic system 300 conveys state information that requests a transition to an LI power state.

To convey the state information, device 370 prepares a state packet in the format of state packet 400. Since this relates to power management state information, the encoding parameters shown in table 450 apply. The power management state packet is then transmitted by device 370 to IO endpoint 330 on PCI-Express communication link 352.

Once the data packet is transmitted by device 370, the process moves to block 610. In block 610, IO endpoint 330 receives the power management state packet and the process moves to block 620.

In block 620, in response to control logic 220, format engine 210 selectively invokes an instance of translation feature 212. Translation feature 212 reads at least a portion of the power management state packet. Translation feature 212, based on the reading, identifies the device sending the information and then accesses a translation table (e.g. stored in memory 230) to interpret the state information encoded in the power management state packet. Translation feature 212 based, at least in part on the translation table, determines the new encoding parameters to translate the state and device ID information. The state and device ID information is then inserted into a packet to generate a translated packet in the format of translated packet 500.

Since the state information is related to a PI-8 event, and the event is power management state information, the encoding parameters shown in tables 450 and 550, respectively, apply to this translation process. Once the translated packet in the format of translated packet 500 is generated, the process moves to block 630.

In block 630, the translated packet is then transmitted by IO endpoint 330 to host endpoint 320. The translated packet is transmitted through AS communication links 314. Once the translated packet is transmitted, the process moves to block 640.

In block 640, the translated packet is received by host endpoint 320. The process then moves to block 650.

In block 650, in response to control logic 220, format engine 210 selectively invokes an instance of decode feature 214. Decode feature 214 reads at least a portion of the translated packet. Decode feature 214 then accesses a translation table (e.g. stored in memory 230) to interpret the translated state information. Based on the translation table, decode feature 214 decodes the translated packet and generates another state packet in the format of state packet 400. Tables 550 and 450, respectively, will apply to this decoding process. Once the other state packet in the format of state packet 400 is generated, the process moves to block 660.

In block 660, host endpoint 320 transmits the other state packet in the format of state packet 400 to root complex 360. The other state packet is transmitted on PCI-Express communication link 356. Once the other state packet is transmitted on PCI-Express communication link 356, the process ends.

In the previous descriptions, for the purpose of explanation, numerous specific details were set forth in order to provide a thorough understanding of the invention. It will be apparent, however, to one skilled in the art, that the invention can be practiced without these specific details. In other instances, structures and devices were shown in block diagram form in order to avoid obscuring the invention.

References made in the specification to “one embodiment” or “an embodiment” means that a particular feature, structure or characteristic described in connection with that embodiment is included in at least one embodiment of the invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily referring to the same embodiment.

References made in the specification to the term “responsive to” are not limited to responsiveness to only a particular feature and/or structure. A feature may also be “responsive to” another feature and/or structure and also be located within that feature and/or structure. Additionally, the term “responsive to” may also be synonymous with other terms such as “communicatively coupled to” or “operatively coupled to”, although the term is not limited in this regard.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative of, rather than limiting the scope and coverage of the claims appended hereto.

What is claimed is:

1. A method comprising:
receiving a state packet in a first format at an endpoint on a communication link, the state packet from a first device; and
translating the state packet into a second format, the translation to generate a translated packet suitable for communicating the state information through the communication link to another endpoint on the communication link.

2. A method according to claim 1, wherein the state information comprises power management state information associated with the first device.

3. A method according to claim 2, wherein the first format comprises a data link layer packet format compliant with a specification called the PCI-Express Specification.

4. A method according to claim 2, wherein the second format comprises a communication protocol format compliant with a specification called the Advanced Switching Core Specification.

5. A method according to claim 4, wherein the Advanced Switching Core Specification compliant communication protocol format comprises a PCI-Express to Advanced Switching Bridge (PI-8) event power management packet format to indicate power management information.

6. A method comprising:
receiving a translated packet at an endpoint on a communication link, the translated packet received from another endpoint on the communication link, wherein the received translated packet includes state information associated with a first device and was received by the other endpoint in a first format; and
decoding the translated packet, the decoding to generate a state packet in the first format, wherein the state packet is forwarded on another communication link to a second device.

7. A method according to claim 6, wherein the state information comprises power management state information associated with the first device.

8. A method according to claim 7, wherein the first format comprises a data link layer packet format compliant with a specification called the PCI-Express Specification.

9. A method according to claim 7, wherein the translated packet comprises a packet in a communication protocol format compliant with a specification called the Advanced Switching Core Specification.

10. A method comprising:
receiving a state packet in a first format at an endpoint on a communication link, the state packet from a first device;
translating the state packet to a second format, the translation to generate a translated packet to facilitate transmission of the state packet through the communication link to another endpoint on the communication link;
transmitting the translated packet through the communication link to the other endpoint;
decoding, at the other endpoint, the translated packet to generate another state packet in the first format; and
transmitting the other state packet on another communication link to a second device.

11. A method according to claim 10, wherein the state information comprises power management state information associated with the first device.

12. A method according to claim 11, wherein receiving the state packet from the first device and transmitting the other state packet on the other communication link comprises receiving and transmitting over communication links operating in compliance with a specification called the PCI-Express Specification.

13. A method according to claim 12, wherein the first format comprises a data link layer packet format for indicating power management state information.

14. A method according to claim 11, wherein the transmitting of the translated packet on the communication link to another endpoint comprises the communication link operating in compliance with a specification called the Advanced Switching Core Specification.

15. A method according to claim 14, wherein the second format comprises a PCI-Express to Advanced Switching Bridge (PI-8) event power management packet format to indicate power management information.

16. An apparatus comprising:
an endpoint on a communication link; and
a translation manager, responsive to the endpoint, to translate a state packet in a first format to a second format, the state packet received from a device, wherein the translation manager generates a translated packet in the second format suitable for communicating the device's state information through a communication link to another endpoint.

17. An apparatus according to claim 16, further comprising:
the endpoint receives the state packet from the device through a PCI-Express communication link operated in compliance with a specification called the PCI-Express Specification.

18. An apparatus according to claim 16, wherein the communication link comprises an advanced switching communication link operated in compliance with a specification called the Advanced Switching Core Specification.

19. An apparatus according to claim 16 further comprising:
a memory coupled to the endpoint to store translation information, wherein the memory is accessed by the translation manager to generate the translated packet in the second format.

20. An apparatus according to claim 16, the apparatus further comprising:
a memory to store executable content; and
a control logic, communicatively coupled with the memory, to execute the executable content, to implement an instance of the translation manager.

21. An apparatus according to claim 20, wherein the control logic comprises control logic implemented in a network processor.

22. An apparatus comprising:
an endpoint on a communication link;
a translation manager, responsive to the endpoint, to decode a translated packet received by the endpoint from another endpoint on the communication link, the received translated packet includes state information associated with a first device and received by the other endpoint in a first format, wherein the translation manager decodes the translated packet to generate a state packet in the first format, the state packet to be forwarded on another communication link to a second device.

23. An apparatus according to claim 22, further comprising:
a memory coupled to the endpoint to store translation information, wherein the memory is accessed by the translation manager to decode the translated packet to generate the state packet in the first format.

24. An apparatus according to claim 22, the apparatus further comprising:
a memory to store executable content; and
a control logic, communicatively coupled with the memory, to execute the executable content, to implement an instance of the translation manager.

25. A system comprising:
a power source;
an endpoint, responsive to the power source, to provide processing resources to the system; and
a translation manager, responsive to the endpoint, to translate a state packet in a first format to a second format, the state packet received from a device, wherein the translation manager generates a translated packet in the second format suitable for communicating the device's state information through the communication link to another endpoint.

26. A system according to claim 25, further comprising:
the endpoint receives the state packet from the first device on another communication link, the other communication link operating in compliance with a specification called the PCI-Express Specification.

27. A system according to claim 26, wherein transmission of the translated packet from the endpoint through the communication link comprises the communication link operating in compliance with a specification called the Advanced Switching Core Specification.

28. A system according to claim 25, wherein the endpoint includes a volatile memory to store an encoding parameter table.

29. A system according to claim 28, wherein the encoding parameters table is accessed by the translation manager to generate the translated packet in the second format based, at least in part, on the encoding parameters.

30. A machine-accessible medium comprising content, which, when executed by a machine, causes the machine to:
receive a state packet in a first format at an endpoint on a communication link, the state packet from a first device; and
translate the state packet into a second format, the translation to generate a translated packet suitable for communicating the state information through the communication link to another endpoint on the communication link.

31. A machine-accessible medium according to claim 30, wherein the first format comprises a data link layer packet format compliant with a specification called the PCI-Express Specification.

32. A machine-accessible medium according to claim 30, wherein the second format comprises a communication protocol format compliant with a specification called the Advanced Switching Core Specification.

33. A machine-accessible medium according to claim 32, wherein the Advanced Switching Core Specification compliant communication protocol format comprises a PCI-Express to Advanced Switching Bridge (PI-8) event power management packet format to indicate power management information.

34. A machine-accessible medium comprising content, which, when executed by a machine, causes the machine to:
receive a state packet in a first format at an endpoint on a communication link, the state packet from a first device;
translate the state packet to a second format, the translation to generate a translated packet to facilitate transmission of the state packet through the communication link to another endpoint on the communication link;
transmit the translated packet through the communication link to the other endpoint;
decode, at the other endpoint, the translated packet to generate another state packet in the first format; and
transmit the other state packet on another communication link to a second device.

35. A machine-accessible medium according to claim 34, wherein to receive the state packet from the first device and to transmit the other state packet on the other communication link comprises to receive and transmit over communication links operated in compliance with a specification called the PCI-Express Specification.

36. A machine-accessible medium according to claim 34, wherein to transmit the translated packet on the communication link to another endpoint comprises the communication link operated in compliance with a specification called the Advanced Switching Core Specification.
